(19) United States
(12) Patent Application Publication
(10) Pub. No.: US 2002/0052783 A1
(43) Pub. Date: May 2, 2002

(54) Method and apparatus for establishing a customized electronic site

(76) Inventors: David G. Turek, Calabasas, CA (US); Jon Y. Saferstein, Los Angeles, CA (US); Lisbeth J. Schaibly, Los Angeles, CA (US)

Correspondence Address: BROMBERG & SUNSTEIN LLP, 125 SUMMER STREET, BOSTON, MA, 02110-1618, US

(21) Appl. No.: 09/892,205

(22) Filed: Jun. 26, 2001

Related U.S. Application Data
(60) Provisional application No. 60/214,301, filed on Jun. 26, 2000.
(60) Provisional application No. 60/220,310, filed on Jul. 24, 2000.

(51) Int. Cl. G06F 17/60

(52) U.S. Cl. 705/14; 705/27

(57) ABSTRACT

In one embodiment of the invention there is provided a method for establishing a customized electronic site for the purposes of providing products. The method includes obtaining over a network information specifying criteria for the customized electronic site, wherein the criteria includes a selection of products and descriptions, and using the information to automatically establish a customized electronic site. Automatically establishing a customized electronic site may include automatically establishing a database containing the specified criteria. Other databases may automatically be established as needed or desired.

The present application contains subject matter related to provisional patent application No. 60/214,301, filed Jun. 26, 2000, and provisional patent application No. 60/220,310, filed Jul. 24,2000, both of which are hereby incorporated herein by reference.

### TECHNICAL FIELD

The present invention relates to systems and methods for the conduct of business over communications networks, and more particularly to systems and methods for automatically establishing customized web sites.

### BACKGROUND ART

It is known in the prior art to provide web sites for e-commerce. Such web sites may be purchased through a provider at a specified cost, or self-designed over a significant period of time. Establishing a web site in this manner is generally time consuming (usually two to six months) because it requires that the user or purchaser provide detailed information pertaining to the design of the web site. Further, if the web site is used to conduct business, a user or purchaser must provide a detailed description of the goods or services supplied by the web site. The user is usually also responsible for supplying the inventory of the site or arranging the inventory to be managed by others.

### SUMMARY OF THE INVENTION

In accordance with one embodiment of the present invention, a method is provided for establishing a customized electronic site for the purpose of providing products. The method includes obtaining over a network information specifying criteria for the customized electronic site, wherein the criteria includes a selection of products and descriptions, and using the information to automatically establish a customized electronic site. The information may be obtained by a primary electronic site, and the primary electronic site may include a first selection/purchase engine. The primary electronic site may be a web site.

Automatically establishing a customized electronic site may include automatically establishing a database containing the specified criteria. Automatically establishing a customized electronic site may also include automatically establishing a database containing a selection of products and descriptions, as well as a database containing format preferences for the customized electronic site. Further, automatically establishing a customized electronic site may include replicating the first selection/purchase engine for use by the customized electronic site, or enabling the customized electronic site to access the first selection/purchase engine. Automatically establishing the customized electronic site may also include providing a second selection/purchase engine for use by the customized electronic site.

The network may be the Internet or the World Wide Web, and the customized electronic site may be a web page. The products may include goods, services, or information. The information may be obtained by providing a template that elicits user-specified data, such as a web page.

In accordance with another embodiment of the invention, the method may include obtaining a set of user or consumer ratings of the selection of products and descriptions, or obtaining other feedback relevant to the primary electronic site, customized electronic site or products. The set of ratings and/or feedback may then be analyzed to enable a primary electronic site, or a customized electronic site, to automatically suggest products that confirm to a user's or consumer's preferences. The analysis may be performed using a preference analysis methodology such as a collaborative filtering process.

In accordance with yet another embodiment of the invention the customized electronic site pertains to customized goods and the criteria includes customization data pertinent to customizing the goods. The customization data may include a logo and the logo may be transmitted to a primary electronic site via electronic upload, electronic download, facsimile, e-mail, or any other relevant mode of transmission.

In accordance with another embodiment of the invention, an apparatus for providing a customized electronic site includes a primary electronic site and at least one dedicated server for serving the primary electronic site. The primary electronic site has a root directory for collecting information pertinent to the customized electronic site. The primary electronic site may also include a selection/purchase engine, which may include a computer program product. The apparatus also includes a primary database in communication with the dedicated server, and the database includes images and descriptions of products offered by the primary electronic site and by the customized electronic site.

In accordance with another embodiment of the invention, the apparatus may include at least one secondary database in communication with the at least one dedicated server, the secondary database including images and descriptions of goods offered by the primary electronic site and by the customized electronic site. Both the primary database and the secondary databases may also include descriptions of services offered by the customized electronic site. The input and output of electronic data may be via wired or wireless connections.

### BRIEF DESCRIPTION OF THE DRAWINGS

The foregoing features of the invention will be more readily understood by reference to the following detailed description, taken with reference to the accompanying drawings, in which:

FIG. 1 is a flow chart illustrating a method for establishing a customized electronic site for the purpose of providing products in accordance with one embodiment of the present invention;

FIGS. 2(a)-(b) are a flow-chart illustrating a detailed method for establishing a customized electronic site in accordance with another embodiment of the present invention;

FIG. 3 is a flow chart illustrating a method for establishing a customized electronic site in accordance with a further embodiment of the present invention;

FIG. 4 is a flow chart illustrating a method of establishing a customized electronic site according to another embodiment of the present invention;

FIG. 5 is a block diagram illustrating an apparatus for establishing a customized electronic site in accordance with another embodiment of the present invention;

FIG. 6 illustrates a web page for a primary electronic site in accordance with an embodiment of the present invention;

FIG. 7 illustrates a web page providing an action interface in accordance with the embodiment of FIG. 6;

FIGS. 8(a)-(d) illustrate a web page providing user selection interfaces in accordance with the embodiment of FIG. 6;

FIGS. 9(a)-(c) illustrate a web page providing a user confirmation interface in accordance with the embodiment of FIG. 6;

FIG. 10 illustrates a web page providing a user information interface in accordance with the embodiment of FIG. 6;

FIG. 11 illustrates a web page providing a user payment interface in accordance with the embodiment of FIG. 6;

FIG. 12 illustrates a web home page of a customized electronic site in accordance with the embodiment of FIG. 6;

FIG. 13 illustrates a web page providing an invoice interface in accordance with the embodiment of FIG. 6;

FIG. 14 illustrates a web page providing a consumer option interface in accordance with the embodiment of FIG. 6;

FIGS. 15(a)-(b) illustrate web pages providing consumer selection interfaces in accordance with the embodiment of FIG. 6;

FIG. 16 illustrates a web page providing a consumer search interface in accordance with the embodiment of FIG. 6;

FIG. 17 illustrates a web page providing a consumer information interface in accordance with the embodiment of FIG. 6;

FIG. 18 illustrates a web page providing a consumer payment interface in accordance with the embodiment of FIG. 6;

FIG. 19 illustrates a web page providing a consumer invoice interface in accordance with the embodiment of FIG. 6;

FIG. 20 is a block diagram illustrating a system for creating customized electronic sites in accordance with another embodiment of the present invention; and

FIG. 21 is a flow chart illustrating a method for creating a customized electronic site in accordance with a further embodiment of the present invention.

### DETAILED DESCRIPTION OF SPECIFIC EMBODIMENTS

Definitions. As used in this description and the accompanying claims, the following terms shall have the meaning indicated, unless the context otherwise requires:

An “electronic site” is an arrangement including a server, accessible over a network by a population of potential consumers, pursuant to which a member of the population may enter into a transaction involving products. Thus, an “electronic site” includes a web site pursuant to which products may be purchased, but excludes a web site that merely offers a link to a distinct pre-existing web site that offers products.

A “primary electronic site” refers to a server configuration on a network that hosts establishment of one or more electronic sites in accordance with systems and methods disclosed herein.

A “user” is a person, corporation, or other entity that uses the primary electronic site to create a secondary electronic site.

A “consumer” is a person, corporation, or other entity that purchases or retrieves products from the secondary electronic site.

A “product” is any item of goods, services, or information that may be provided to a user or consumer.

A “selection/purchase engine” is an interface that electronically drives the selection, purchase, transaction, and invoice processes associated with an electronic site.

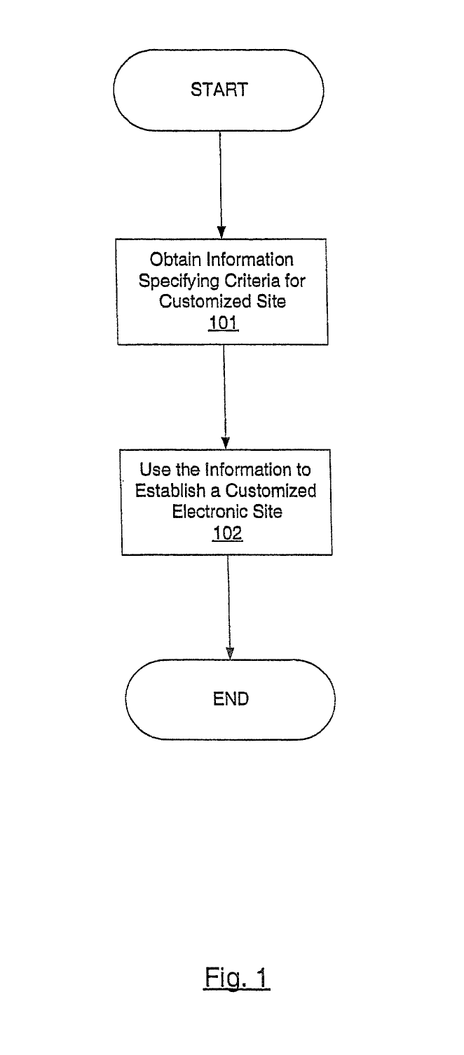

FIG. 1 is a flow chart illustrating a method for establishing a customized electronic site for the purpose of providing products in accordance with one embodiment of the present invention. In process 101 information specifying criteria for a customized electronic site is obtained. The criteria include a selection of products and descriptions that will be offered by a user to a consumer. This is accomplished over a network such as the Internet including, for example, the World Wide Web. The information may be obtained by a primary electronic site, or other electronic device, through the Internet, or it may be obtained through e-mail or facsimile, or other methods of transmittal. The primary electronic site may provide a template that elicits user-specified data. An example of such a template would be a web page.

The criteria may include a selection of goods descriptions or a selection of pre-specified goods descriptions. For example, the user may provide the primary electronic site with its own selection of goods descriptions, or the user may select a selection of products offered by the primary electronic site. Similarly, the criteria may be a selection of services descriptions that may be described by the user or selected from services described by the primary electronic site. The criteria may also relate to information, such as legal cases, articles, books, etc. In process 102, the primary electronic site, or other electronic device, uses the information to automatically establish a customized electronic site.

The customized electronic site may provide a web page representing a storefront, office, library, etc. Further, the customized electronic site may be established to store computer resources associated with the primary electronic site, as well as an IP address (or other network address) that is derived from a network address associated with the primary electronic site, and thereby accessed through the primary electronic site. Alternatively, the customized electronic site may be separate and distinct from the primary electronic site.

If the products offered to the consumer are goods, they may be customized through the primary electronic site. For example, the goods may be customized with the user's logo or name. A logo may be transmitted to the primary electronic site by way of electronic upload or download. It would also be within the scope of the invention to transmit a user's logo to the primary electronic site through an e-mail message, facsimile, or any other relevant form of transmission. The primary electronic site may provide a selection of goods and effect delivery of the goods to a user or consumer in bulk or individually. The primary electronic site may also provide a selection of services and effect the performance of the service for the user or consumer. The primary electronic site may also inventory the products of the customized electronic site for the user.

In further embodiments of the invention, the criteria may include a selection of pre-specified marketing materials, such as advertisements for the products offered to the consumer by the user, that is transmitted across the network. The criteria may also include a selection of links that are transmitted across the network. The links may include data ports or may lead directly to information pertinent to the products. The criteria may also include a selection of linkages between the primary electronic site and the customized electronic site or between the customized electronic site and resources pertinent to the customized electronic site.

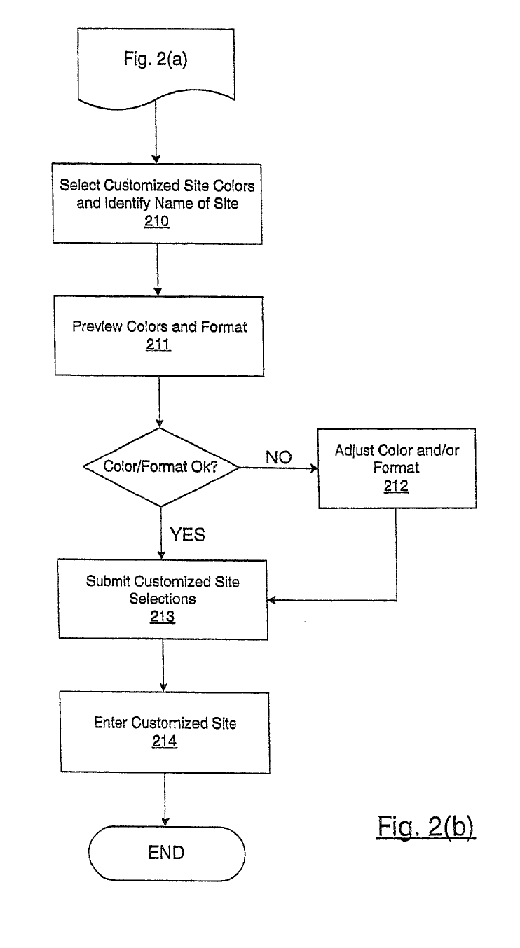

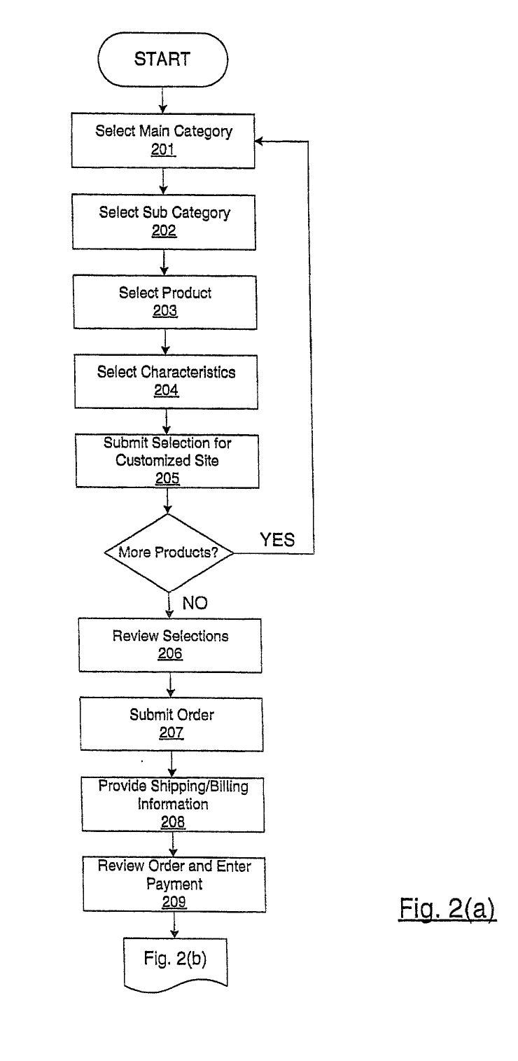

FIGS. 2(a)-(b) are a flow-chart illustrating a method for establishing a customized electronic site in accordance with another embodiment of the present invention. As is shown in FIG. 2(a), a user selects a main category of products from the primary electronic site in process 201. Such main categories may be designated in the manner of different types of stores, departments in a store, aisles in a grocery store, types of insurance, levels and jurisdictions of court systems, etc. For example, main categories for users who provide insurance to consumers may be LIFE INSURANCE, FIRE INSURANCE, AUTO INSURANCE, HEALTH INSURANCE, and ANNUITIES. Main categories for users who provide employees in a company articles containing the company's logo may be OFFICE SUPPLIES, CLOTHING, GLASSWARE, etc. In process 202 the user then selects a sub category. For the previous examples, sub categories of FIRE INSURANCE may be HOME, APARTMENT, or BUSINESS and sub categories of OFFICE SUPPLIES might be STAPLERS, DESK MATS, CALCULATORS, PENS, PENCILS, and so on.

The user then selects a specific item in process 203 and a specific characteristic for that item, such as color or border design if applicable, or perhaps terms and deductibles, in process 204. The user submits the item as a product of the user's customized electronic site in process 205. At this point, the user may decide to select more products or not. To select more products, the user simply repeats processes 201-205; otherwise the user continues on to process 206 to review the selections made. At this point, the user may delete products, change characteristics, change the quantity of products ordered, or add more products. After the user has reviewed the selections, the order is submitted to the primary electronic site in process 207.

In process 208, the user provides the primary electronic site with billing information such as the user's address, phone number, facsimile number, e-mail address, check number, account number, or credit card number. The user may also provide shipping information as needed. The user then reviews the order again in process 209 and confirms the payment information.

In process 210, shown if FIG. 2(b), the user selects colors for the customized electronic site and provides a name for the customized electronic site. The user is then able to preview the colors and format selected in process 211. If the color and/or format must be adjusted, the user can do so in process 212. When the color and format preferences are satisfactory, the user submits the selections to the primary electronic site in process 213. The user may then enter the customized electronic site in process 214. At any time after this customized electronic site is created, the user may re-enter the primary electronic site to add, delete, or modify colors, products, etc.

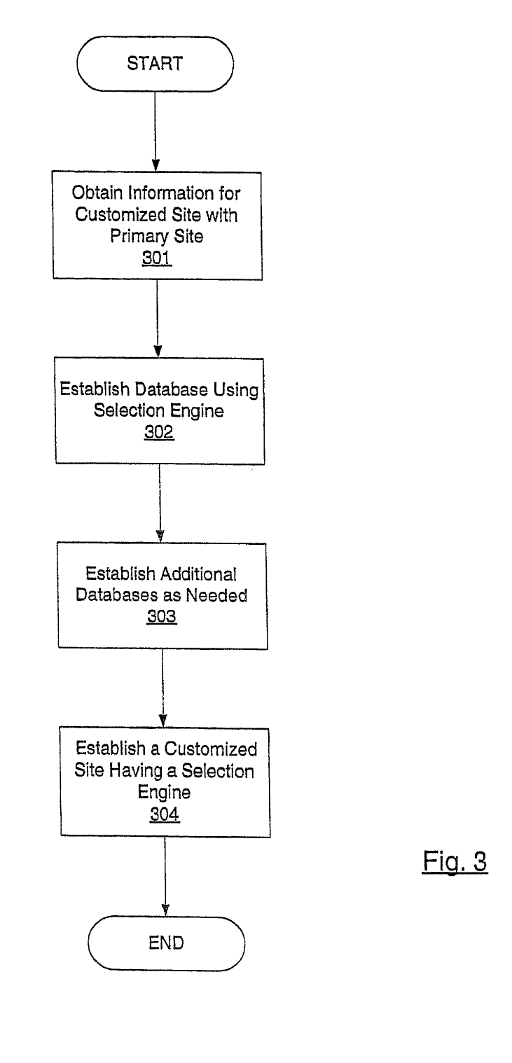

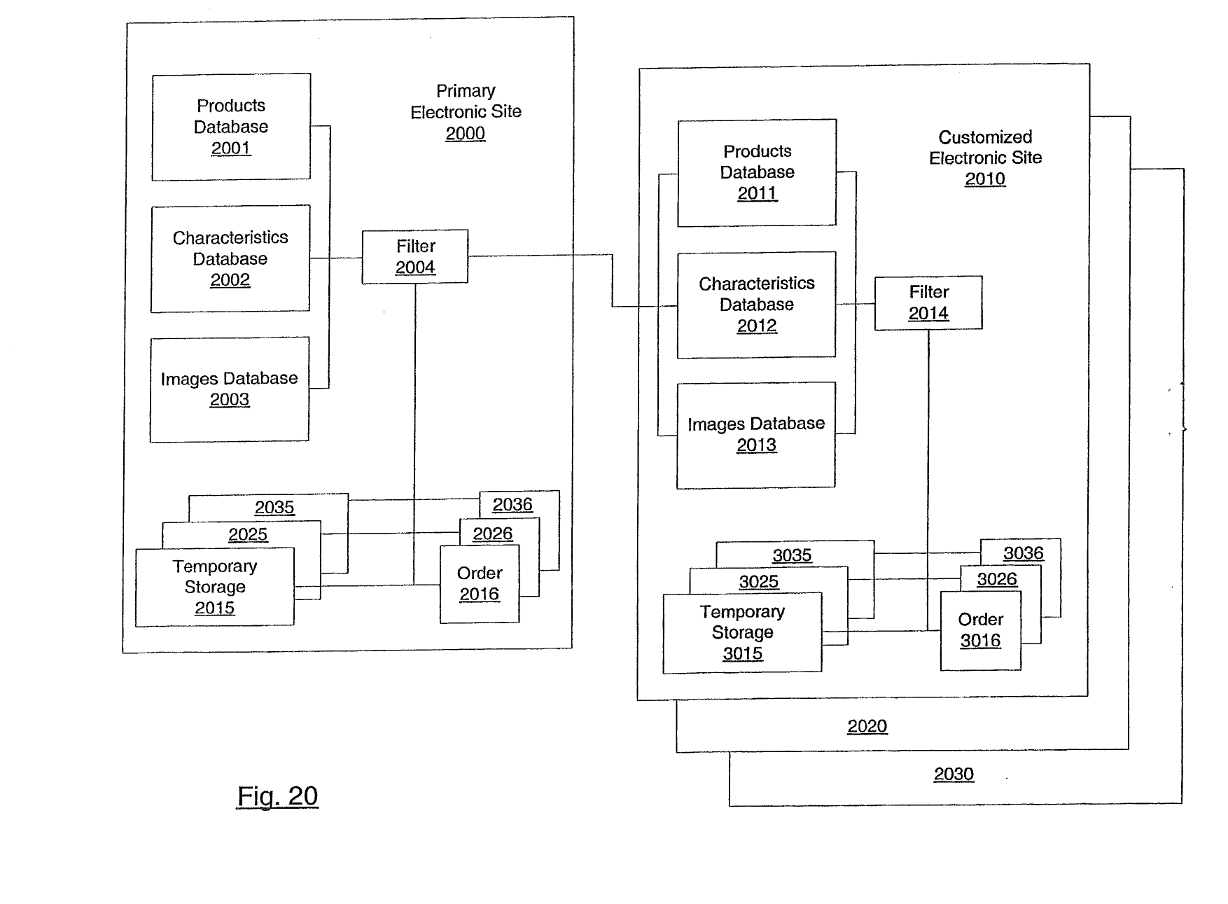

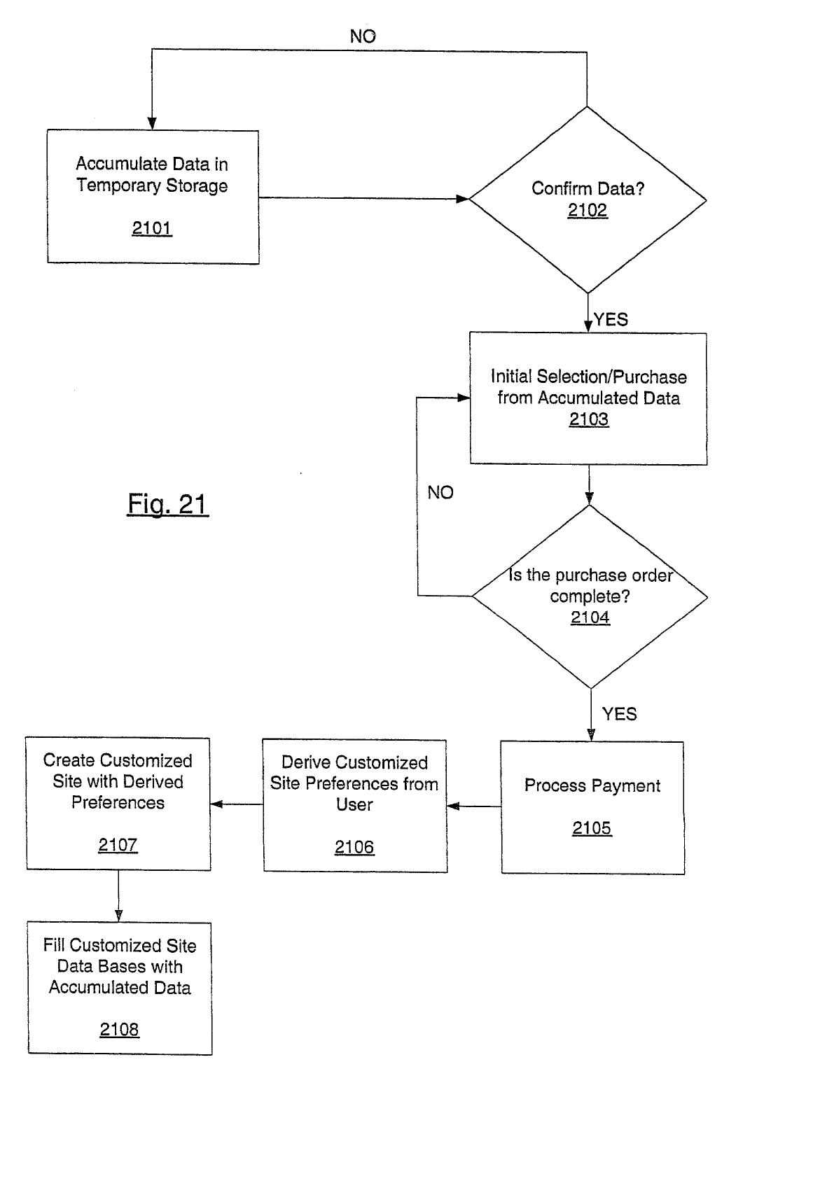

FIG. 3 is a flow chart illustrating a method for establishing a customized electronic site in accordance with a further embodiment of the present invention. In this embodiment, information specifying criteria for a customized electronic site is obtained by a primary electronic site that includes a selection/purchase engine in process 301. A database containing the specified criteria is automatically established in process 302. This may be accomplished by reading data from temporary or pre-existing electronic files or databases and writing the data into a new database using the selection/purchase engine. The selection/purchase engine may be replicated for use by the customized electronic site or the customized electronic site may be enabled to use the selection/purchase engine of the primary electronic site without replication. Similarly, a new selection/purchase engine may be created for the customized electronic site. The selection/purchase engine may comprise a computer program product running on a server associated with the primary electronic site. It should be noted that such a computer program product might be created with HTML code, XML code, JAVA, or C++ but is not limited to any particular language. Further, one skilled in the art will recognize that such a computer program product may provide any number of new databases, and that these new databases may be in communication with the primary electronic site as well as the customized electronic site. Thus additional databases are established as needed or desired in process 303. A customized electronic site is established in process 304. The processes associated with establishing an electronic site are discussed in further detail below in connection with FIGS. 20 and 21.

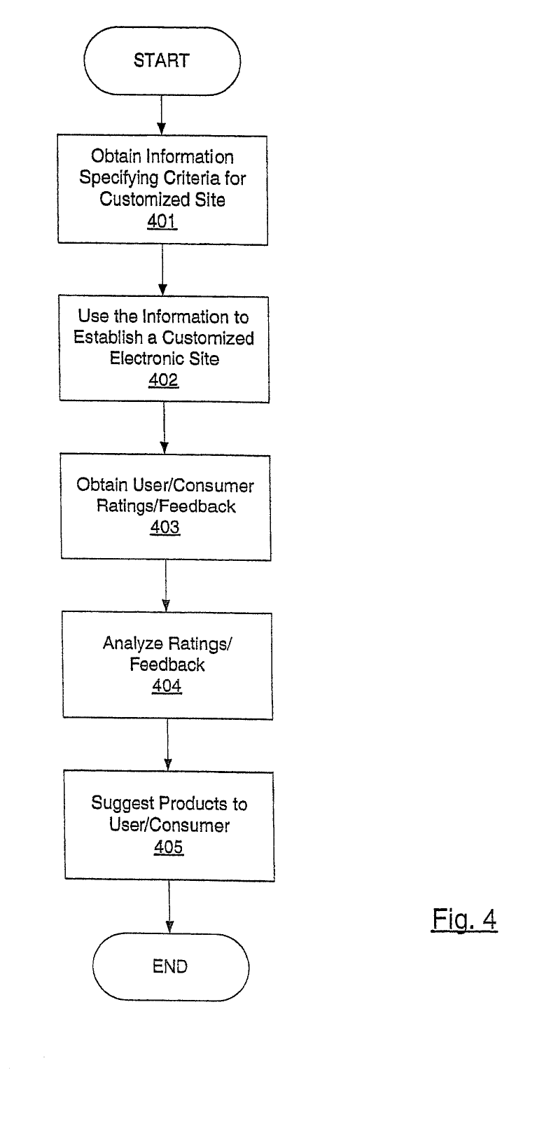

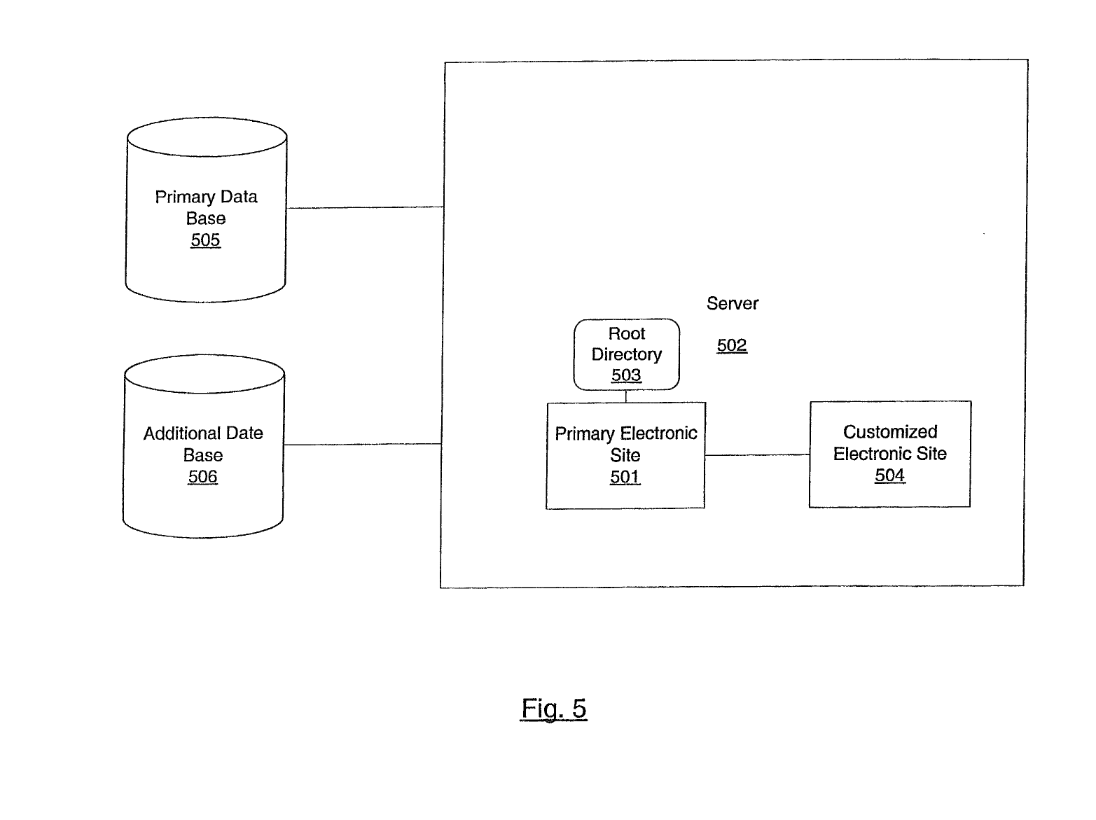

FIG. 4 is a flow chart illustrating a method of establishing a customized electronic site according to another embodiment of the present invention. In this embodiment, information specifying criteria for a customized electronic site is again obtained through, for example, a primary electronic site in process 401. The information is used to establish a customized electronic site in process 402. Once the customized electronic site has been established, user or consumer ratings or feedback concerning the customized or primary electronic site is obtained in process 403. The feedback or ratings may be obtained through the primary electronic site, through the customized electronic site, through an e-mail message, e-mail attachment, and/or HTML link, or otherwise digitally or electronically transmitted. A ratings questionnaire may be sent to the users or consumers to elicit the recipient's degree of preference for the products offered by the primary or customized electronic site. The feedback or ratings are analyzed in process 404.

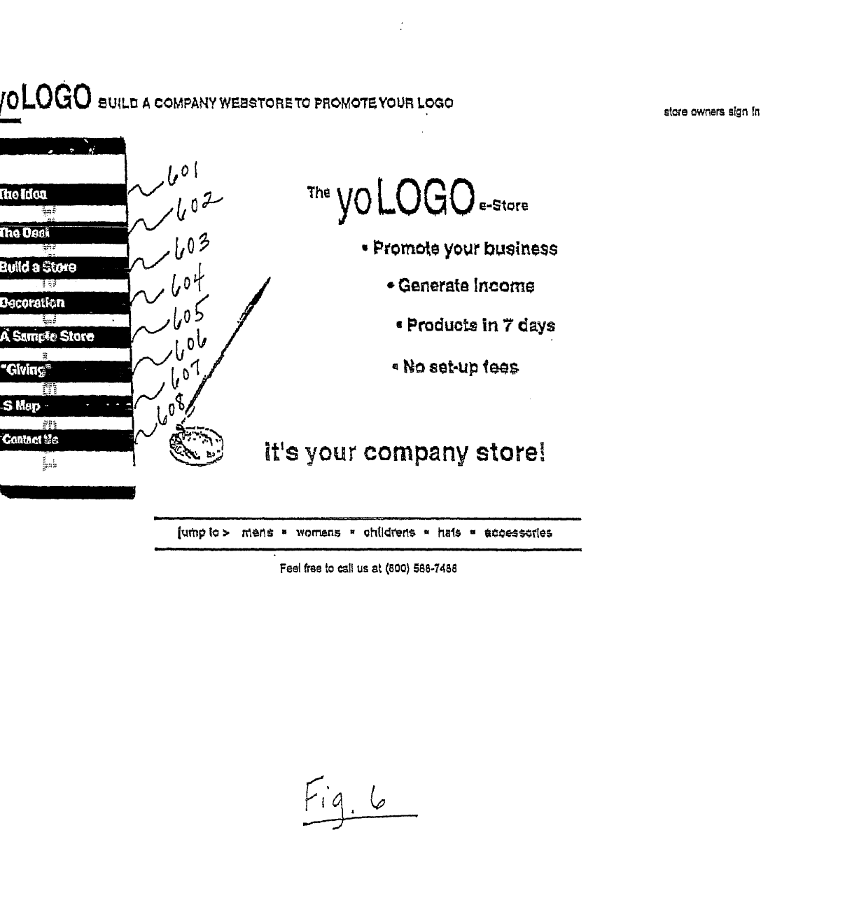

The analysis may be accomplished using a collaborative filtering technique. Collaborative filtering techniques are disclosed in U.S. Pat. No. 6,064,980 issued to Jacobi et al. and U.S. Pat. No. 6,041,311 issued to Chislenko et al., the disclosures of which are herein incorporated may reference. In one embodiment, a preference vector is maintained for each product recipient (user or consumer), containing as elements the recipient's numerical rating of the product. For each given product recipient who has already rated products, a host system, such as the server 502 of FIG. 5, identifies groups of recipients who have the highest correlation of preference vectors with those of the given recipient, and who thus have similar tastes in products. This may be performed, for example, by evaluating the dot product of preference vectors or recipients and selecting a group of recipients having the highest results. Then, for each product that the given recipient has not yet received, the system determines how highly it was rated by the selected group of recipients. Those products that received high ratings by the selected group (for example, products that received above a specified average numerical rating, or that received ratings which are relatively high when compared with those of other products that the given recipient has not received) are then suggested to the recipient (user or consumer) in process 405. Thus, products are suggested to recipients in a way that accords with the preferences of other recipients having similar tastes. In this way, the likelihood that a user or consumer enjoys the full value of the customized electronic site is increased.

FIG. 5 is a block diagram illustrating an apparatus for establishing a customized electronic site in accordance with another embodiment of the present invention. The apparatus includes a primary electronic site 501. The primary electronic site includes a root directory 503 for collecting information pertinent to the customized electronic site. The primary electronic site may be hosted on a suitable server 502, which may also host the customized electronic site 504.

A primary database 505 is in communication with the at least one dedicated server 502, but as noted above, additional databases, such as 506 may be established and added as needed or desired. The database 505 includes images and descriptions of products offered by the primary electronic site 501 and by the customized electronic site 504. The database may also include format information for the customized electronic site 504, user and/or consumer product preferences, billing and delivery information, and so on. Input and output of electronic data to and from the apparatus, or between the components of the apparatus, may be wireless. Similarly, communication may be hardwired, such as through a telephone, modem, cable, or any other viable method.

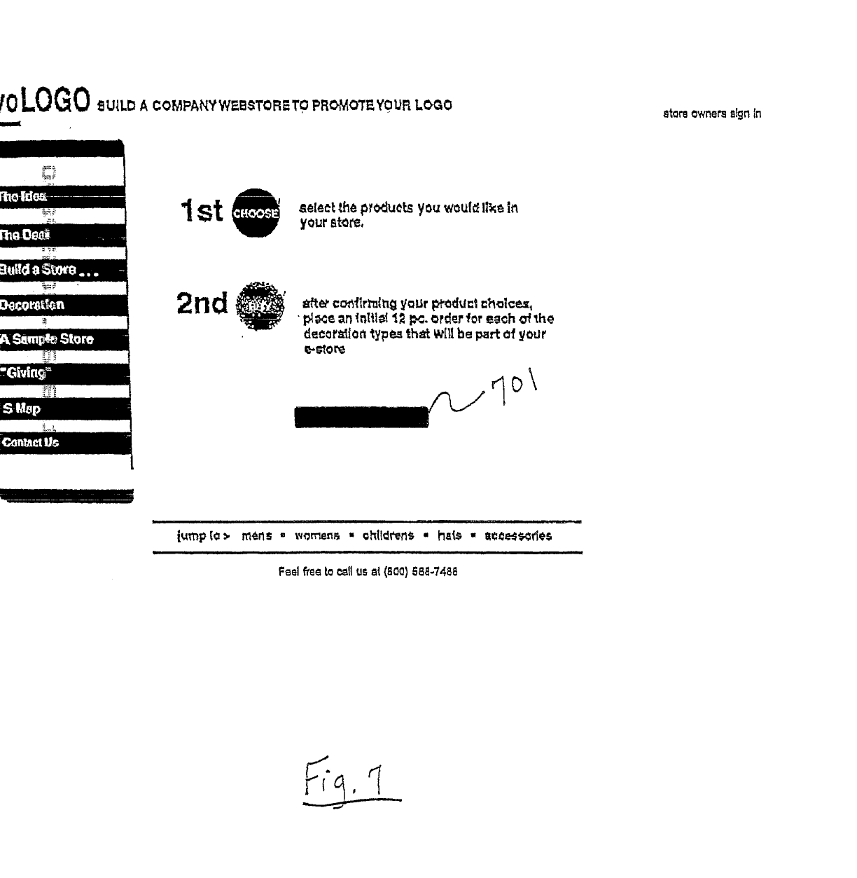

FIG. 6 illustrates a web page for a primary electronic site in accordance with an embodiment of the present invention. In this embodiment, the web page includes a plurality of links 601-608. When a user accesses link 603, the user will be led through a series of processes which begin at another web page that provides a user action interface as shown in FIG. 7. Here, the user chooses link 701 to select the products that will be offered in a customized electronic site.

FIGS. 8(a)-(d) illustrate web pages providing user selection interfaces in accordance with the embodiment of FIG. 6. The user starts by selecting from a plurality pre-specified categories 801-805 as shown in FIG. 8(a). For example, the user may choose category 801 to begin purchasing products geared toward men. The user may then select from a plurality of sub-categories 806-809. In this example, the user selects sub-category 806. As illustrated in FIG. 8(b) the user may then select from variety of items 810-815, such as the “Mock Turtleneck” 812. The selected item 812 is displayed in FIG. 8(c) and the user may then choose the characteristic and color by using links 816. For example, the user may choose link 817 to select the color “Ash” and link 818 to have a logo or name embroidered on the item. After the item has been selected, the interface displays a message 819, as shown in FIG. 8(d), to indicate that an item has been added for the user's customized electronic site. In this example the customized site will be an electronic store for selling, among other things, at least one “Mock Turtleneck” man's shirt.

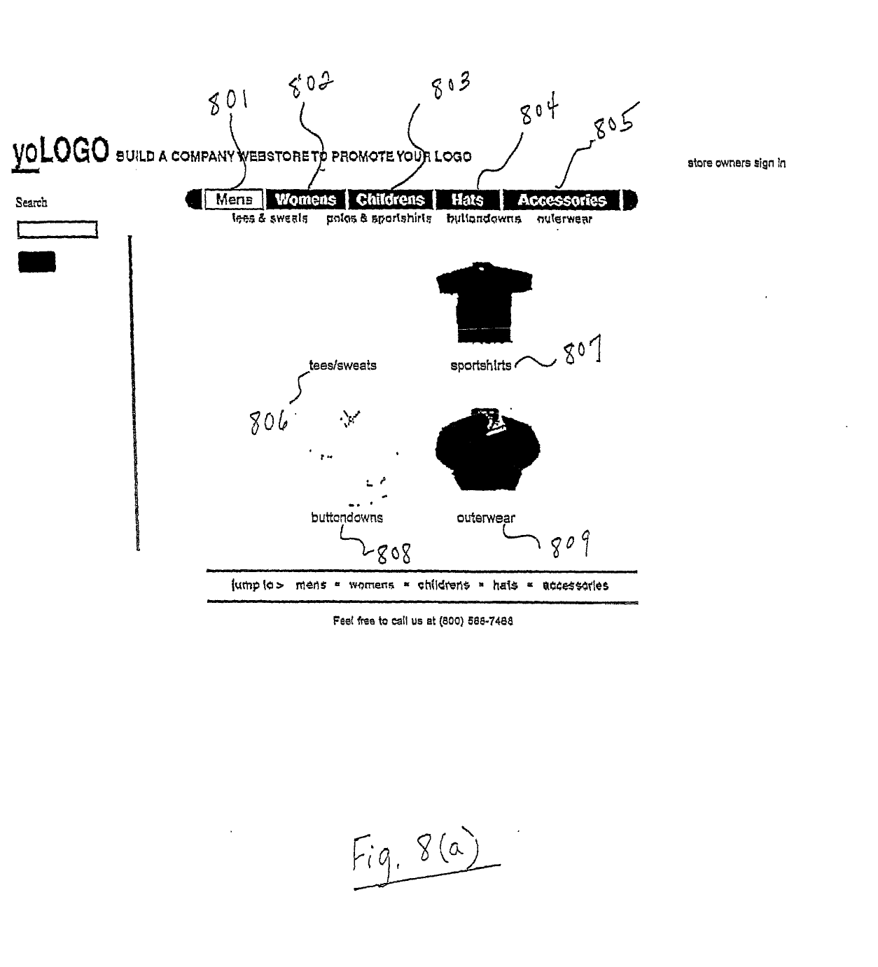

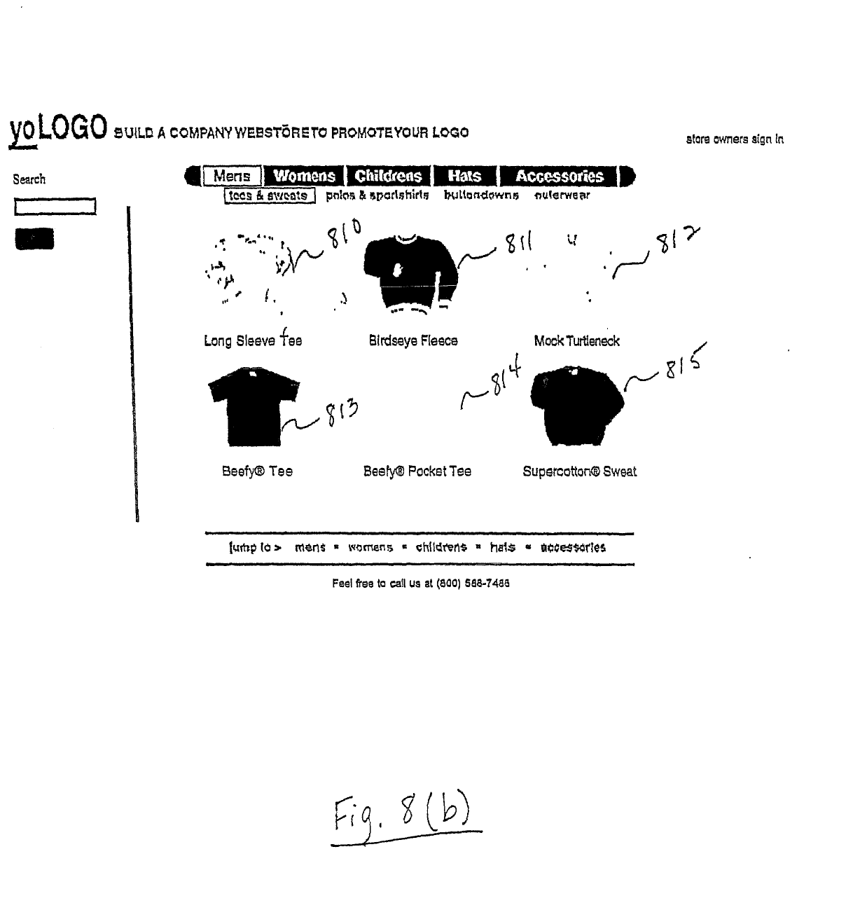

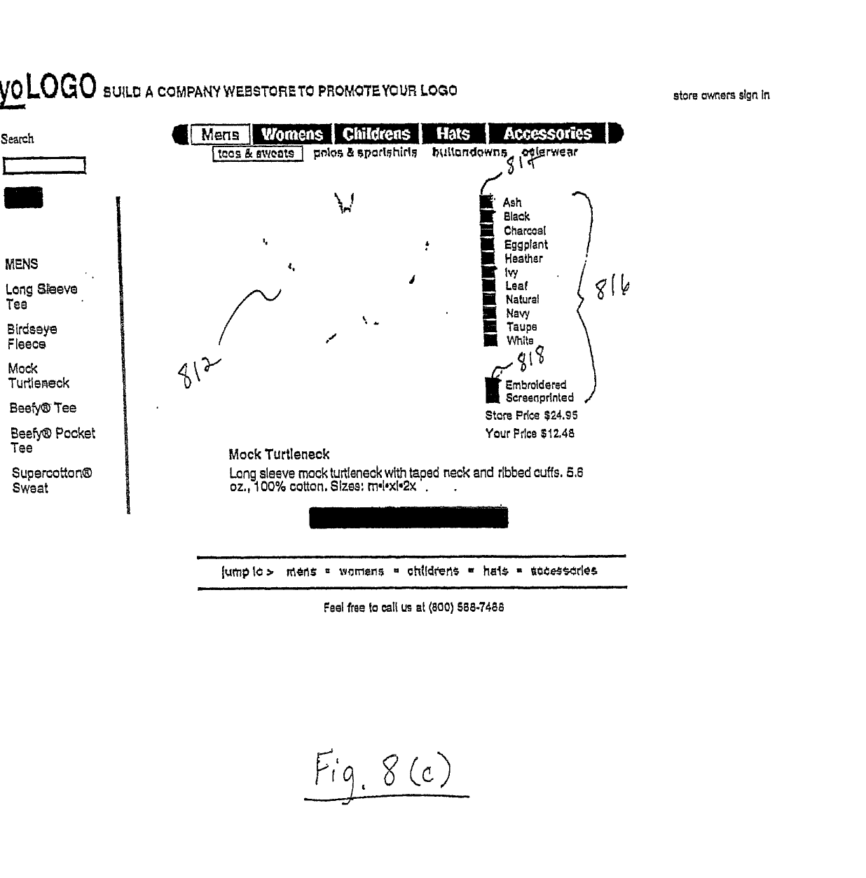

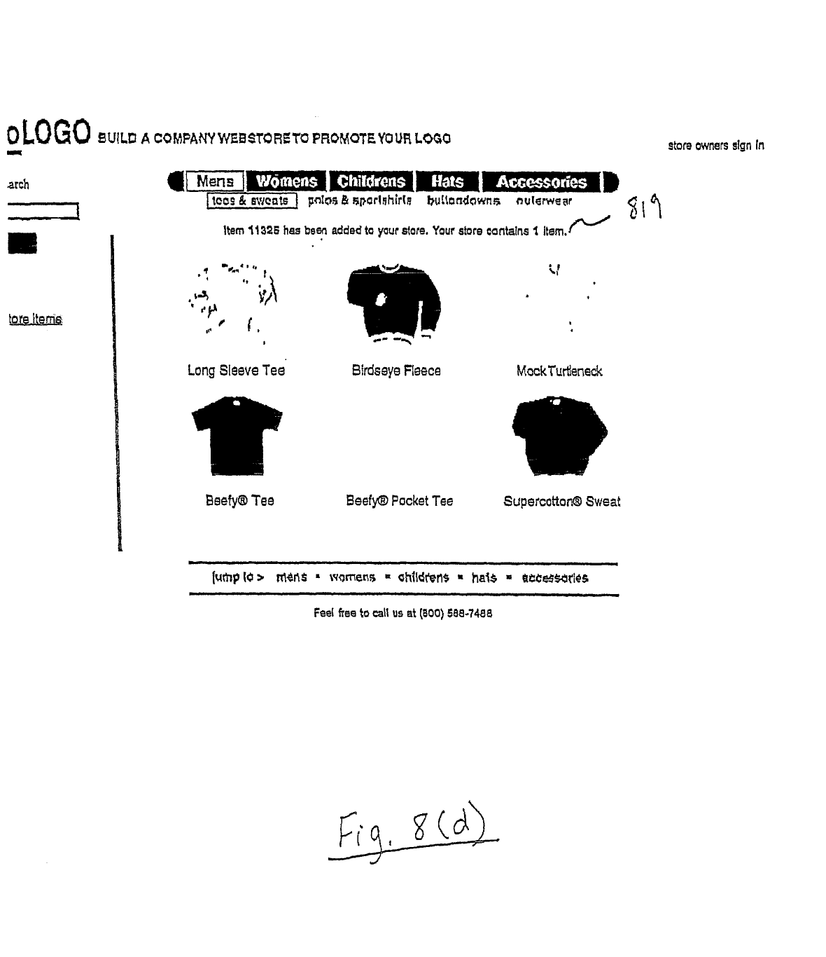

FIGS. 9(a)-(c) illustrate web pages providing a user confirmation interface in accordance with the embodiment of FIG. 6. Through the user confirmation interface a user may review the selections the user has made for use in the user's customized electronic site. As illustrated in FIGS. 9(a) and 9(b), display 901 shows the item number and quantity of that item number previously selected. The user may go to a product chart 902 to see the products displayed according to item number. The user may use links 903 and 904 to purchase an item for the customized site or remove any particular item before submitting an order for the customized site. When purchasing items through link 903, selections the user has made are shown through a display 909, as illustrated in FIG. 9(c). Fields 905-908 are provided so that the user may indicate the desired quantity and size of each item.

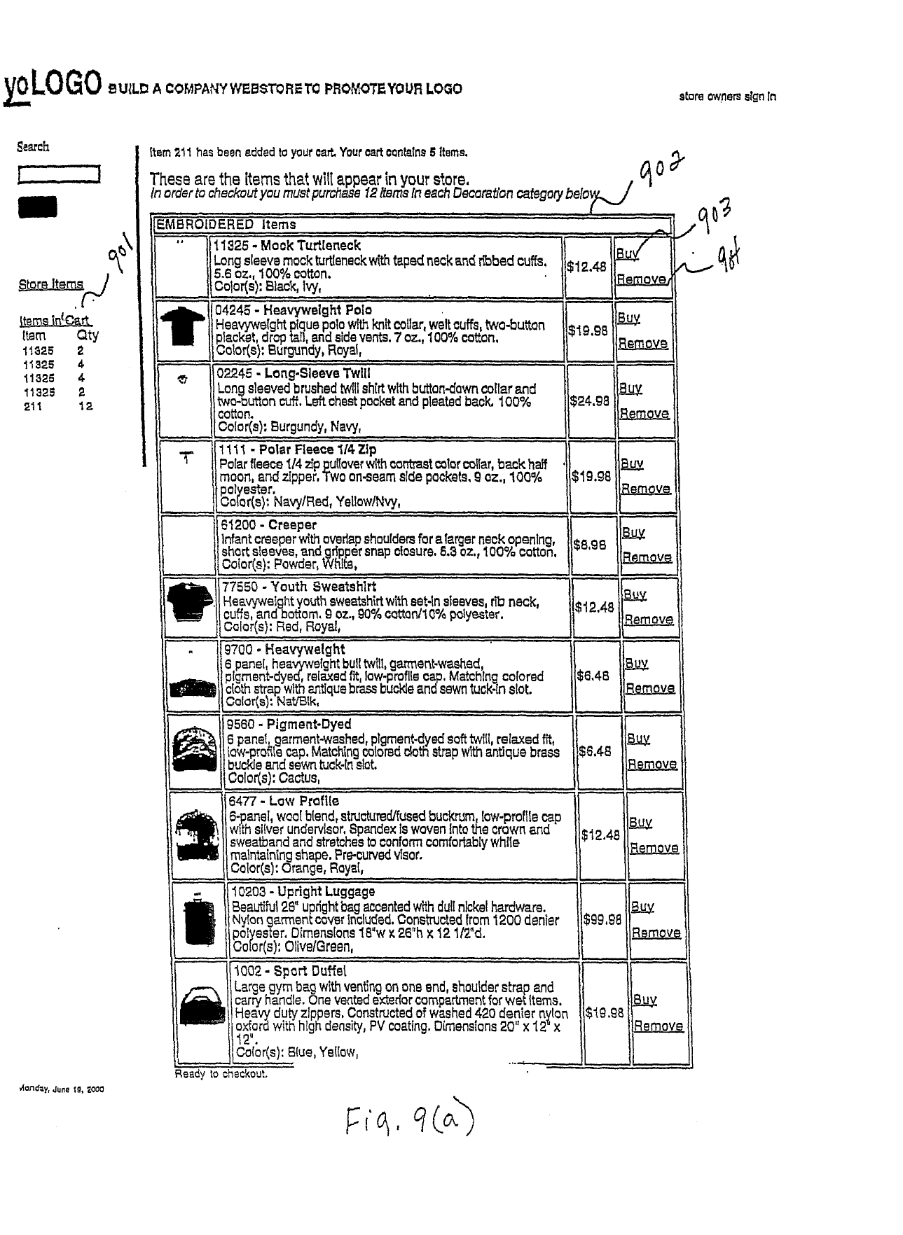

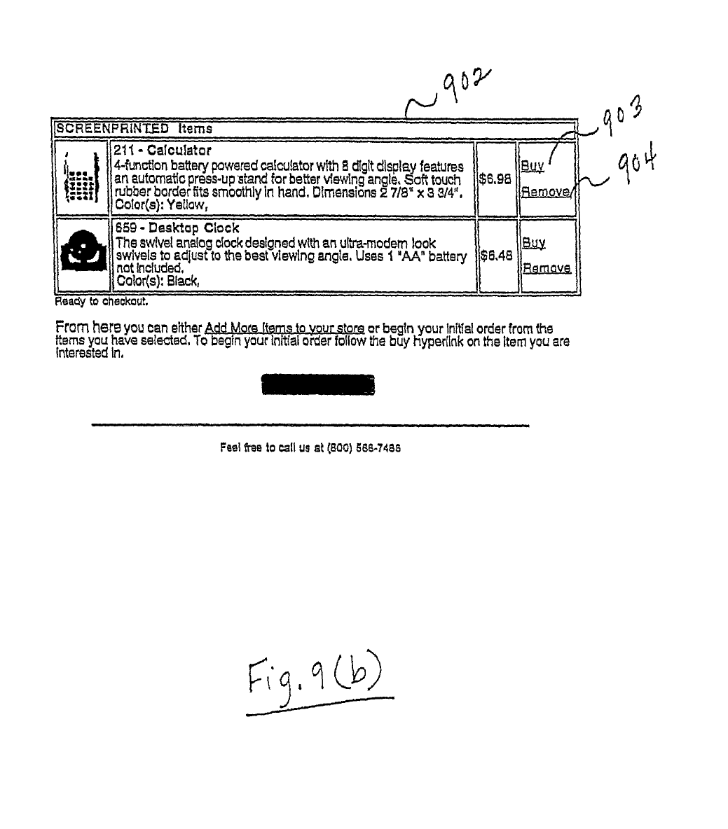

FIG. 10 illustrates a web page providing a user information interface in accordance with the embodiment of FIG. 6. This web page includes a field 1001 for entering a company name and a field 1002 for entering the name of an individual user. Additional fields 1003-1008 are provided for the user's shipping address, city, state, country, and zip code. The user enters a telephone number in field 1009 and an e-mail address in field 1010. There is also a field 1011 wherein a user may enter comments and suggestions. The user may check a field 1012 to indicate that the billing and shipping addresses are the same.

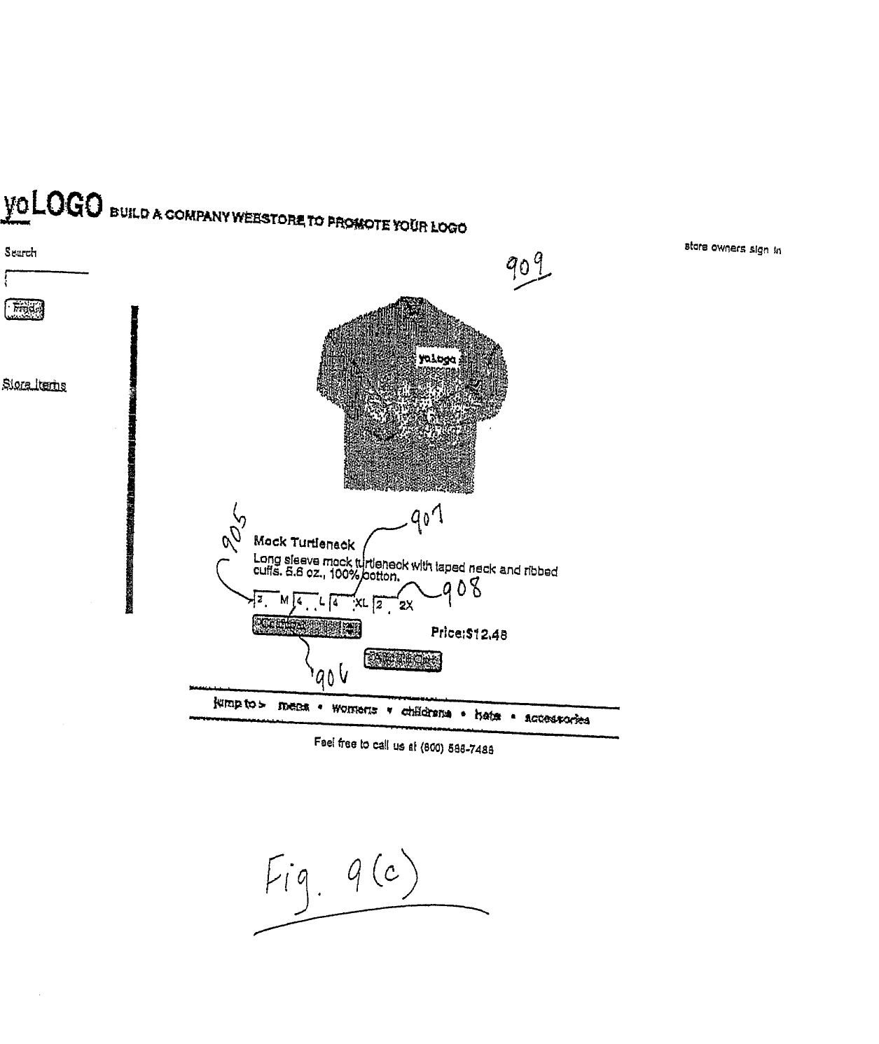

FIG. 11 illustrates a web page providing a user payment interface in accordance with the embodiment of FIG. 6. The web page includes a chart 1101 which displays the product number 1102, the product name 1103, the quantity 1104, the price of the individual product 1104, and the total price for the number of products selected 1106. The chart 1101 also displays the subtotal 1107, applies the appropriate tax and tax rate 1108, the cost of shipping and handling 1109, and the grand total for the entire order 1110. The user payment interface 1100 further includes fields for entering a credit card type 1111, a credit card number 1112, and an expiration date 1113. The user submits this information to the primary electronic site 600.

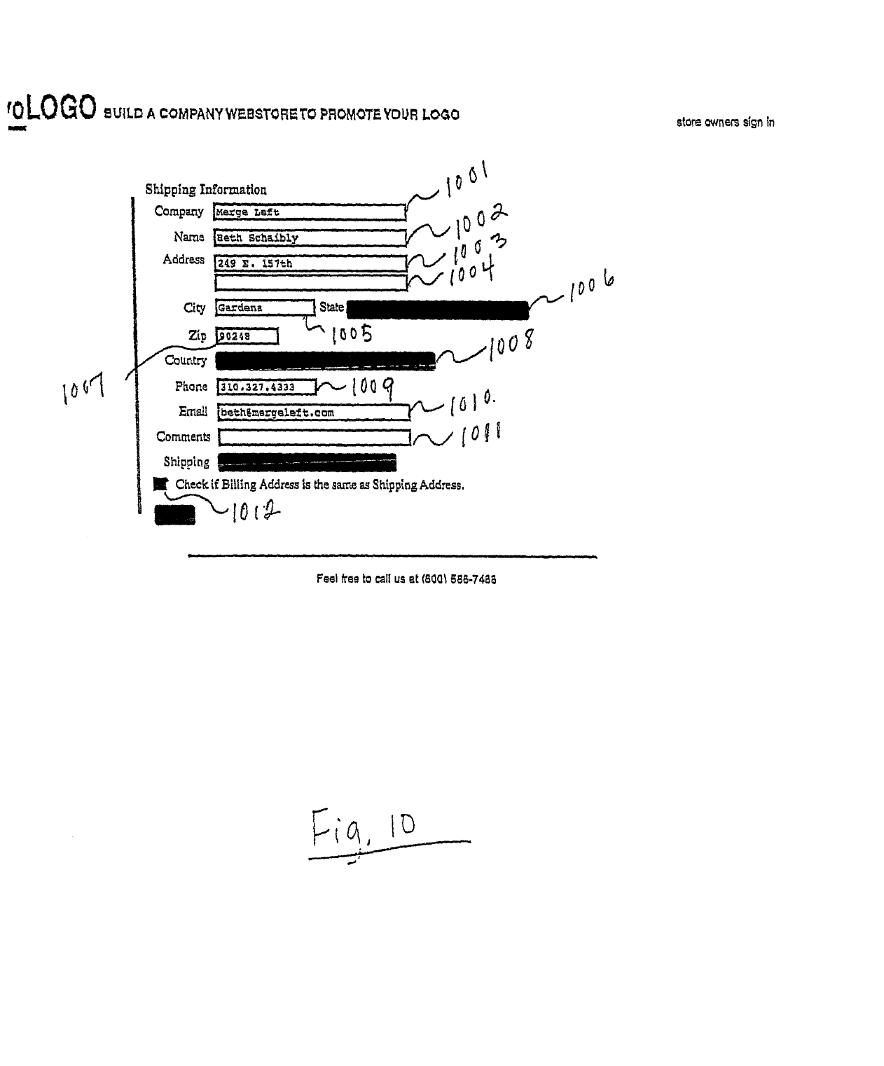

FIG. 12 illustrates a web home page of a customized electronic site in accordance with the embodiment of FIG. 6. Through a series of processes as described with respect to FIG. 2(b), a web page 1200 providing a customized electronic site is established. In this embodiment the colors, name, and format of the customized electronic site are submitted by the user to the primary electronic site via a series of interfaces and selections similar to those described with respect to FIGS. 6-11. In this embodiment, the web page 1200 includes a field 1201 for displaying the site name and a field 1202 for displaying products offered at the site. A third field 1203 displays the main categories under which the products fall and enables a consumer to search through the main categories.

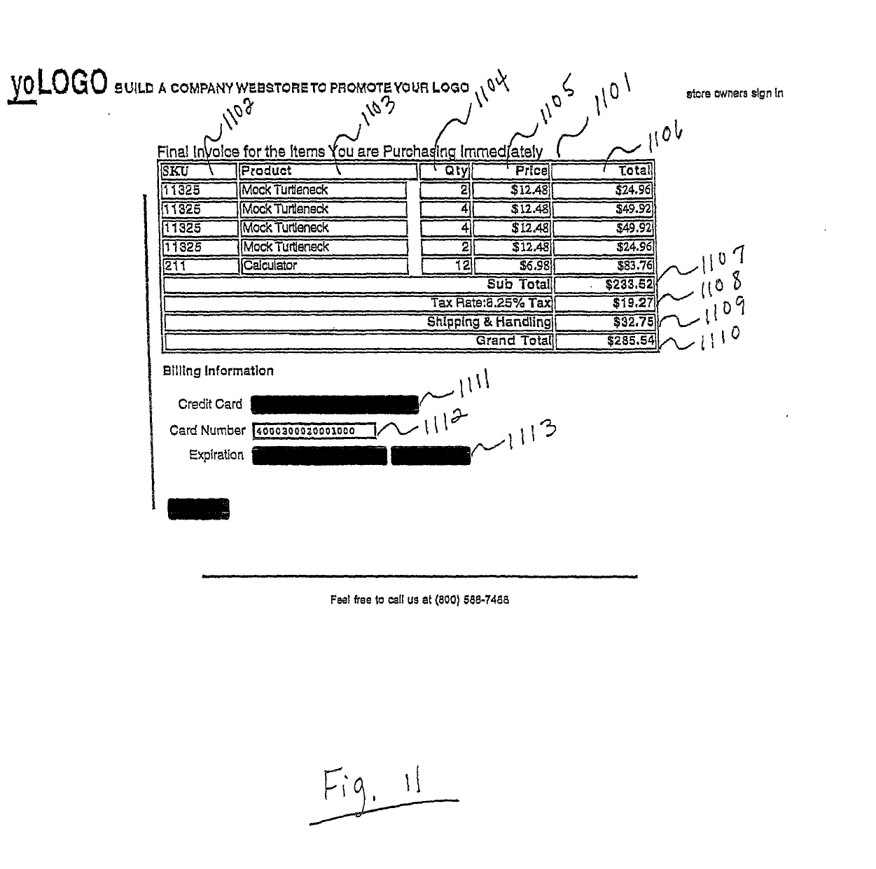

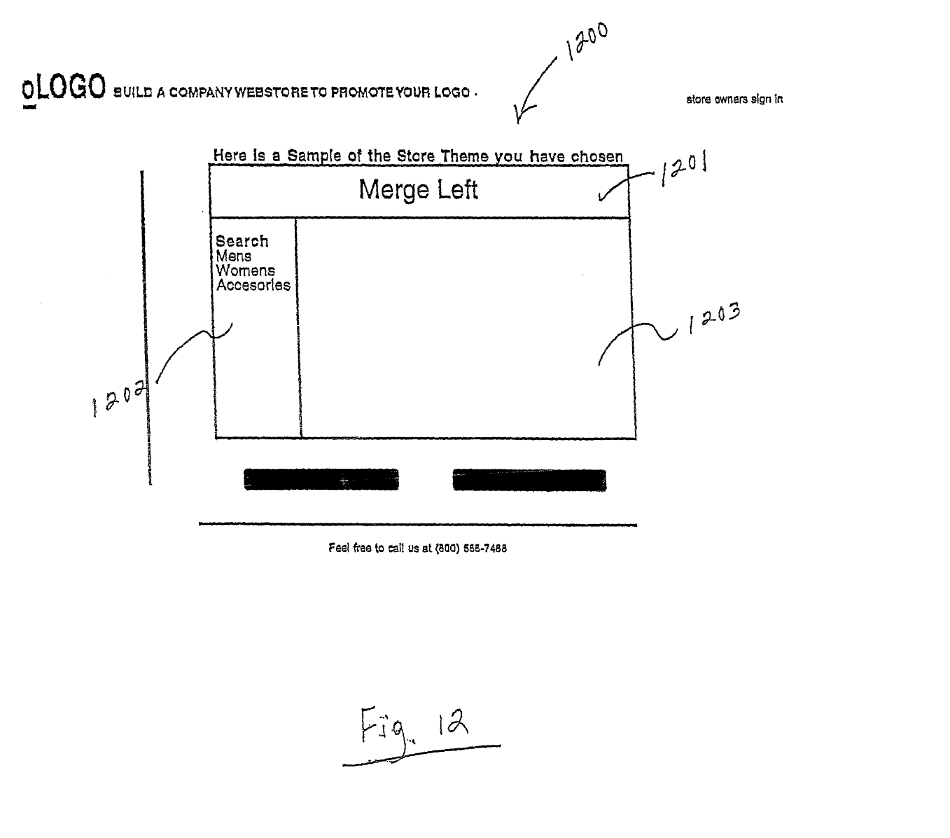

FIG. 13 illustrates a web page providing an invoice interface in accordance with the embodiment of FIG. 6. The web page includes a shipping time period 1301 for the order as well as other comments from the primary electronic site to the user 1302 that may be pertinent to the order. The web page also displays an order number 1303 and order information 1304. A chart 1305 displaying all the information described above with respect to the user payment interface chart 1101 is also included. A link 1306 enables a user to enter the new store or other customized electronic site.

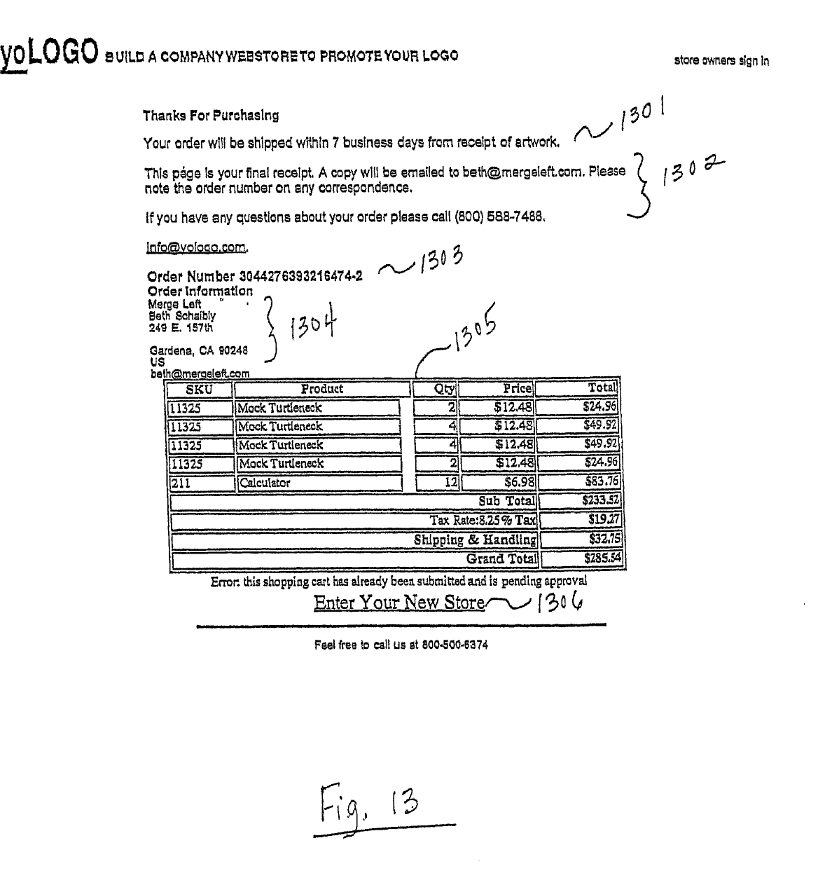

FIG. 14 illustrates a web page providing a consumer option interface in accordance with the embodiment of FIG. 6. This web page includes a display 1402 that shows a consumer what is offered in the customized electronic site. A picture of the items, such as 1408 and 1409 is displayed with the item's name 1410 and price 1411. Links 1403-1407 enable the consumer to view products that fall under the link name category. There is also a link 1401 that enables a consumer to search the customized electronic site.

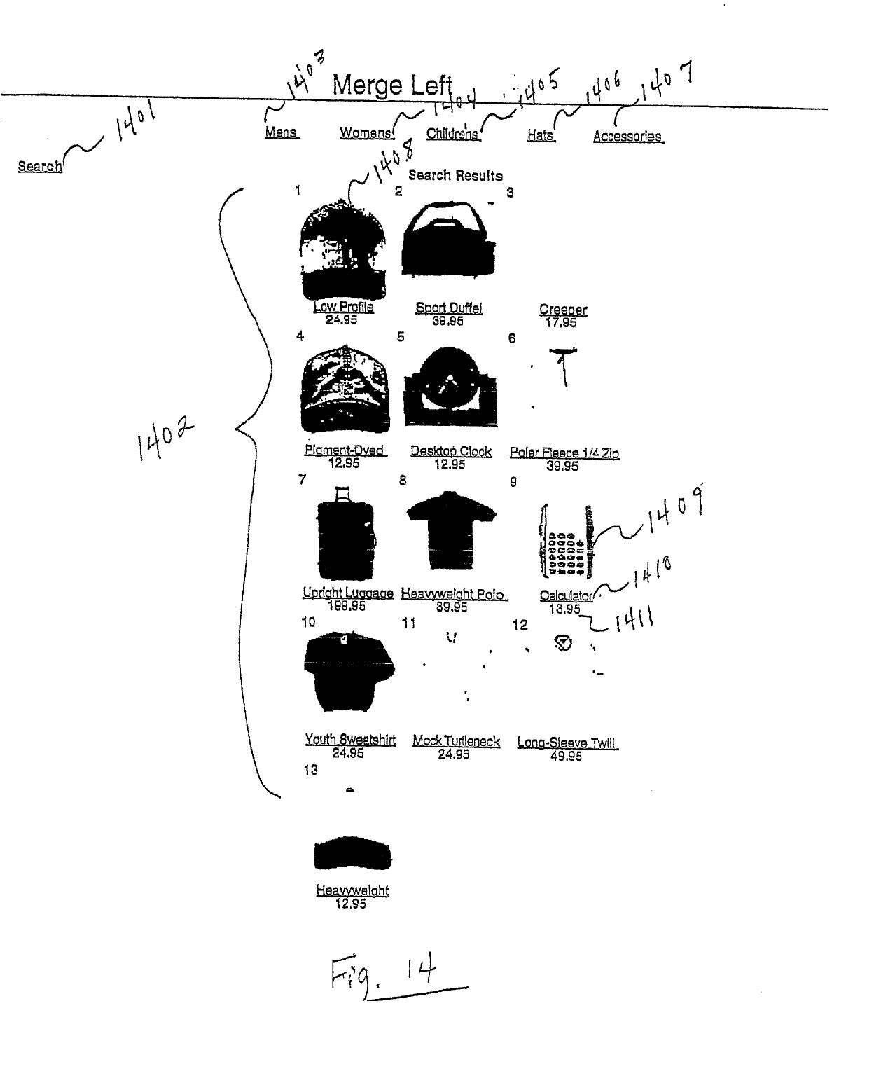

FIGS. 15(a)-(b) illustrate web pages providing a consumer selection interface in accordance with the embodiment of FIG. 6. As shown in FIG. 15(a), this web page displays the selected item 1408 for the consumer, as well as a description of the item 1501 and the price of the item 1502. The consumer may then choose to have a name or logo embroidered on the item through field 1503 or screen-printed on the item 1504 as shown in of the web page of FIG. 15(b). The consumer may enter the quantity of the product he or she wishes to purchase in field 1507 and select a color through field 1506.

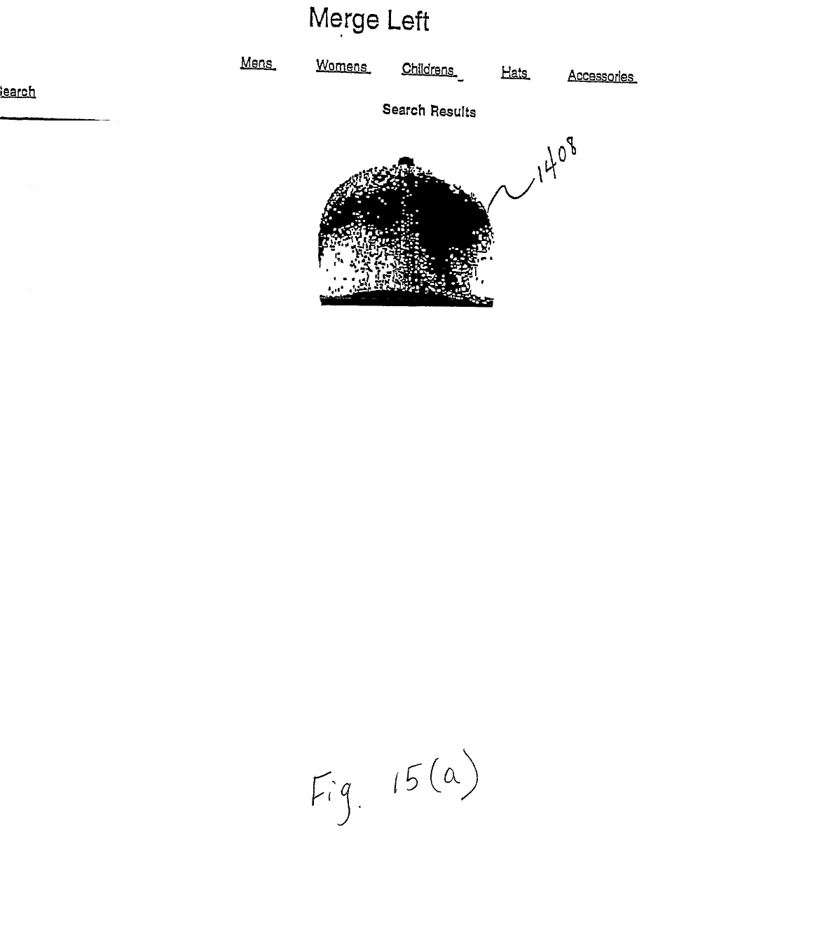

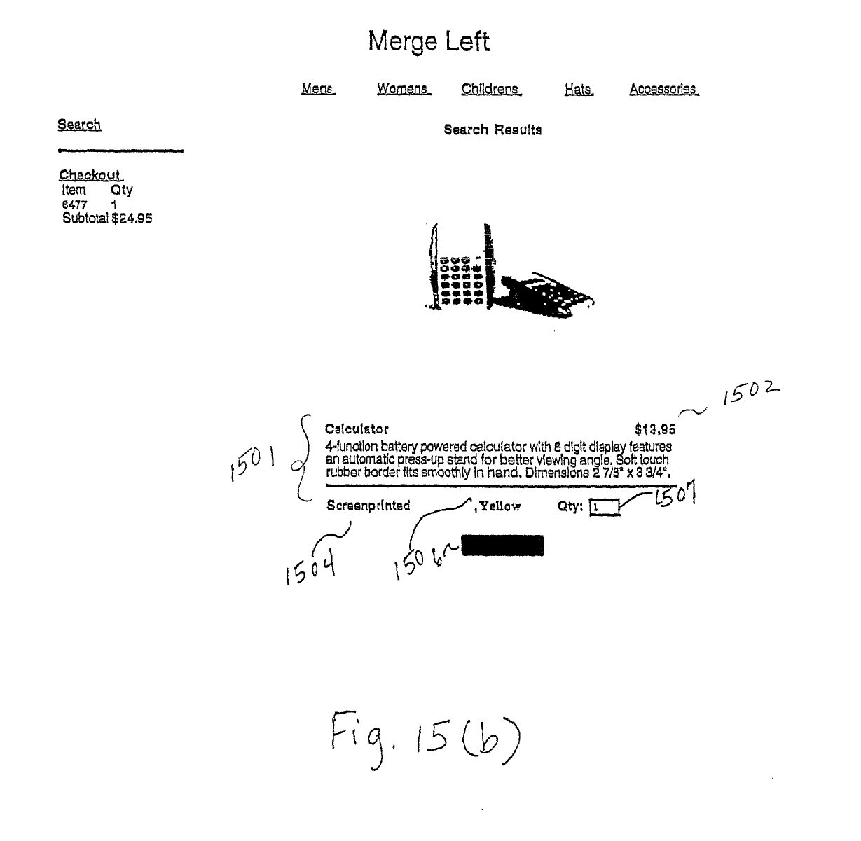

FIG. 16 illustrates a web page providing a consumer search interface in accordance with the embodiment of FIG. 6. This web page provides a search result display 1601 that allows the consumer to view the products in specific categories or with specific characteristics. The item numbers, quantities, and a subtotal for the products that the consumer has selected for delivery may also be viewed in display 1602. When the consumer has finished shopping and selecting, and is ready to purchase the products, he or she may do so through link 1603.

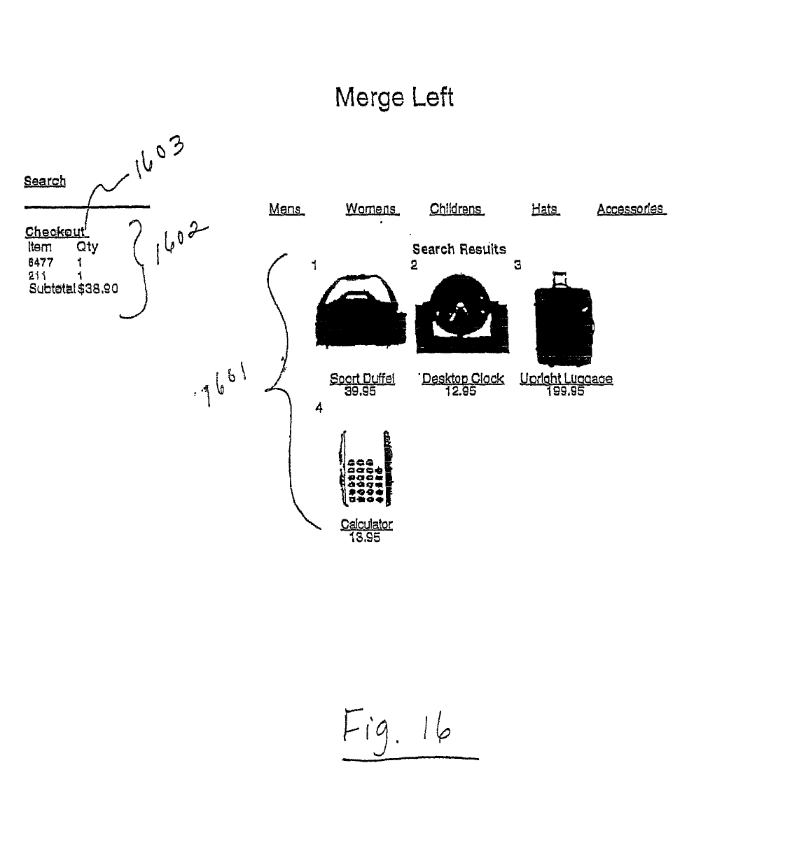

FIG. 17 illustrates a web page providing a consumer information interface in accordance with the embodiment of FIG. 6. This web page provides a display 1701 that shows the item number and quantity of each product the consumer has selected, as well as a subtotal indicating what the consumer has spent. This web page also provides a chart 1702 for displaying the item number, quantity, price of each item, and total price for the quantity selected. The chart 1702 also provides a link 1704 that enables a consumer to remove an item before he or she submits payment. The interface further provides fields 1703 similar to those described with respect to the user information interface of FIG. 10.

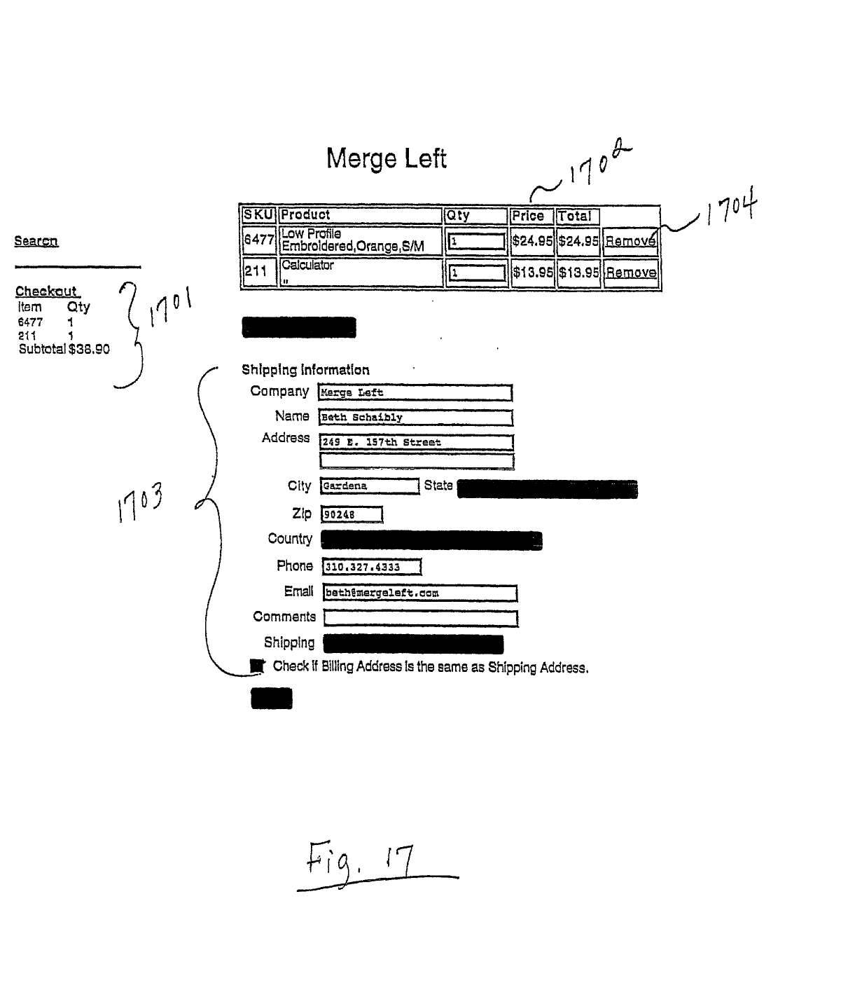

FIG. 18 illustrates a web page providing a consumer payment interface in accordance with the embodiment of FIG. 6. This web page provides a chart 1801 that allows a consumer to view all of the information contained in the chart 1101 described above with respect to FIG. 11. Fields 1802 enable a consumer to enter payment information, such as a credit card number. It should be noted, however, that other methods of payment may be provided through the payment interfaces of FIGS. 11 and 18, such as providing a field for a check number, bank account number, and/or pin number (e.g., for electronic wallets or for withdrawals from pre-payment accounts).

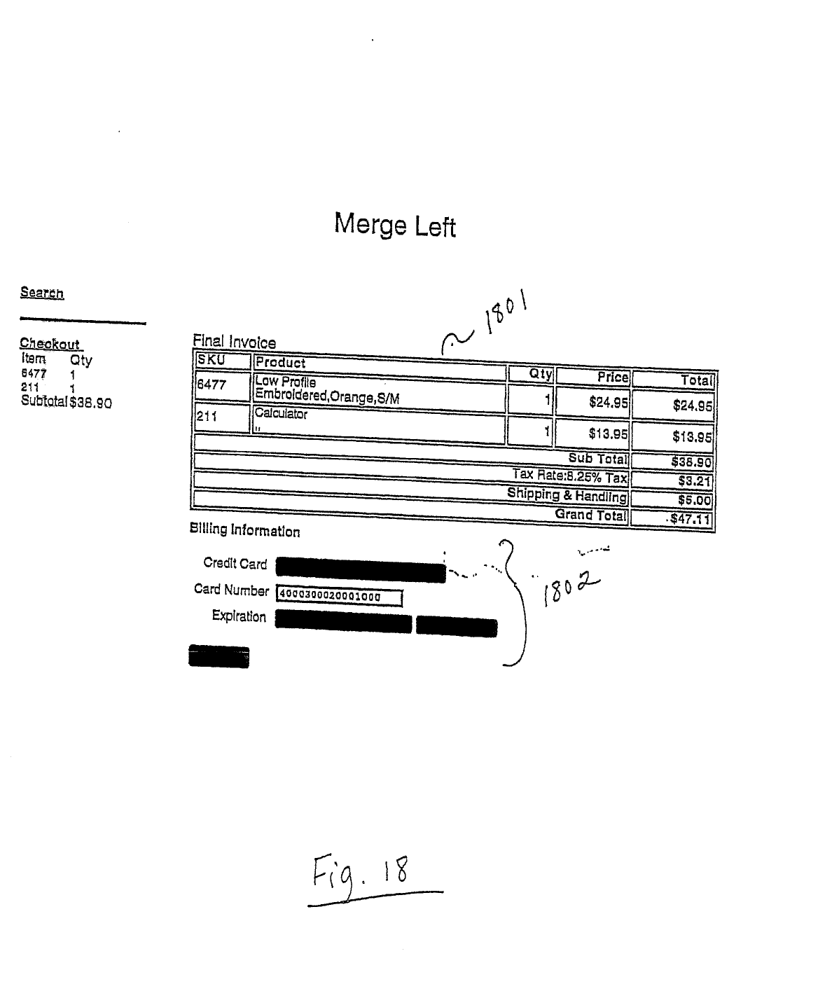

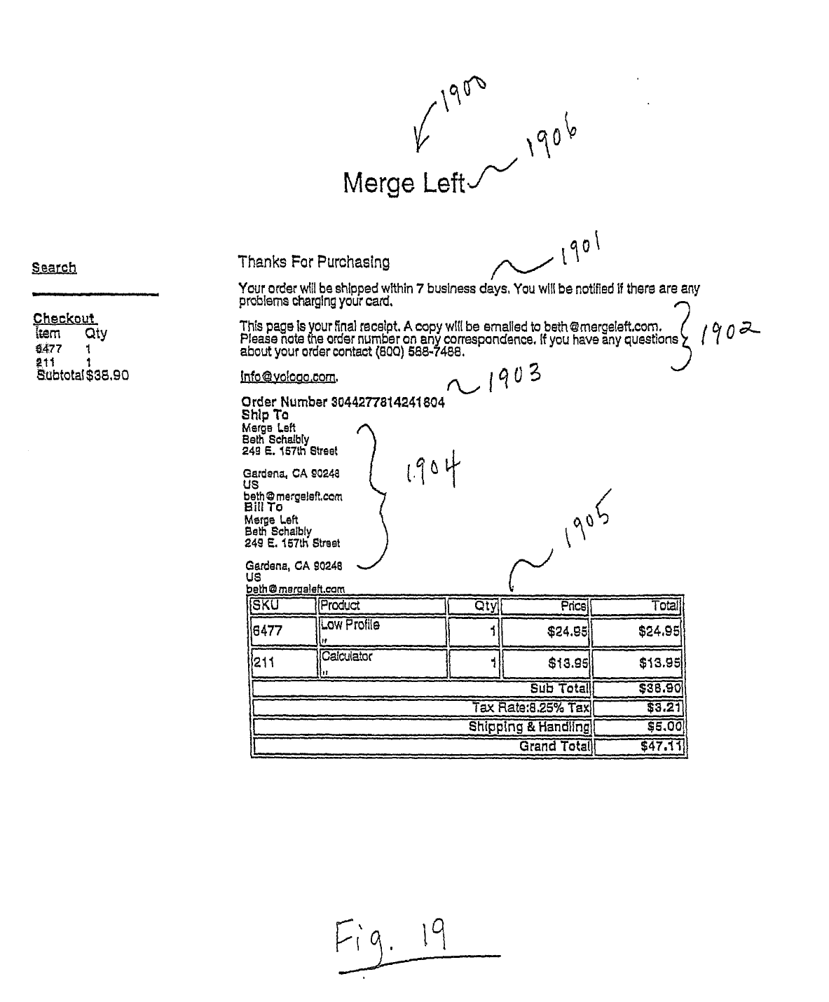

FIG. 19 illustrates a web page providing a consumer invoice interface in accordance with the embodiment of FIG. 6. This web page, like the user invoice interface web page of FIG. 13, provides a shipping time period 1901 for the order as well as other comments 1902 from the primary electronic site or the customized electronic site to the consumer that may be pertinent to the order. The name 1906 of the customized electronic site is also displayed on this invoice. The consumer invoice interface also provides an order number 1903 and shipping and billing information 1904. A chart 1905, displaying all the information described above with respect to the chart 1801 of FIG. 18, is also included.

FIG. 20 is a block diagram illustrating a system for creating customized electronic sites in accordance with an embodiment of the present invention. A primary electronic site 2000 includes a selection/purchase process running on a server in communication with a plurality of primary databases 2001, 2002, and 2003. Primary database 2001 is a product database that contains descriptions and other information specific to individual products that may be offered by the primary electronic site 2000. Primary database 2002 is a database that contains data related to general characteristics that are not specific to any particular product. This database 2002 may contain data related to colors, sizes, prices, etc. Primary database 2003 is in direct communication with products database 2001 and contains images of the products as well as product coding information. The primary electronic site 2000 obtains the products, characteristics, and images for each customized electronic site 2010, 2020 and 2030 from primary databases 2001, 2002, and 2003, in accordance with user selections, in the course of establishing such sites. Of course, the sites 2010, 2020, and 2030 are exemplary; the number of sites that may be configured over a period of time using a given primary electronic site is only a matter of design choice.

In the course of establishing customized electronic sites, the primary electronic site 2000 causes storage of data obtained from the primary databases 2001, 2002, and 2003 in temporary storage facilities 2015 (for customized electronic site 2010), 2025 (for customized electronic site 2020), and 2035 for customized electronic site 2030). Final orders 2016, 2026, 2036 are chosen from the data in temporary storage, and secondary databases, such as databases 2011, 2012, and 2013 associated with the customized electronic site 2010, are established from the data accumulated in temporary storage. Data for temporary storage can be achieved through the use of a filtering program such as CGI shopping filter 2004. The shopping filter 2004 will be duplicated in each the customized electronic sites 2010, 2020, and 2030. Thus, customized electronic site 2010 also has a shopping filter 2014.

By initiating and following through with the purchase/selection engine process running on the primary electronic site , a user obtains a customized electronic site 2010, 2020, or 2030 that is also able to run the purchase/selection process. In addition, each of the customized electronic sites 2010, 2020, and 2030 will have temporary storage facilities, such as 3015, 3025, and 3026 in customized electronic site 2010, for selections and purchases made by a consumer. Final orders 3016, 3026, and 3036 will be chosen from data stored in temporary storage facilities 3015, 3025, 3035 by utilizing the duplicate shopping filter 2014 of the customized electronic site (in this case 2010).

Each of the customized electronic sites 2010, 2020, and 2030 are in communication with the primary electronic site 2000. The secondary databases 2011, 2012, and 2013 are in communication with the customized site 2010. Each of the other customized electronic sites 2020 and 2030 is in communication with its own set of secondary databases. Secondary database 2011 contains product descriptions and other information specific to the products offered at its corresponding customized electronic site 2010. Secondary database 2012 contains data related to general characteristics of the products offered by its corresponding customized electronic site. Although three customized electronic sites 2010, 2020 and 2030 are shown, it should be noted that the primary electronic site 2000 is in communication with all the customized electronic sites it creates, and there is no inherent limit to the possible number of customized electronic sites that can be created.

FIG. 21 is a flow chart illustrating a method followed by the primary electronic site's 2000 process of FIG. 20 in creating a customized electronic site in accordance with a further embodiment of the present invention. In process 2101 product data is accumulated in a temporary storage facility. The temporary storage facility may be a buffer in a computer system. The buffer can be flushed out after the order is complete. A user will make a decision 2102 as to whether data for the customized site is complete and confirm the order or not. If the data is not complete, process 2101 will be repeated. If the data is complete, an initial selection or purchase of products will be performed from the accumulated data in process 2103. A decision 2104 is made as to whether the purchase order is complete. If the purchase order is not complete, process 2103 is repeated. If the purchase order is complete, payment is processed in process 2105. Preferences for the customized site are derived in process 2106. These preferences include characteristics of the customized site itself such as borders, colors, site name, etc. A customized site is created in process 2107 in accordance with the preferences that were derived in process 2106. Databases specific to the customized site are filled with inventory from the accumulated data in process 2108.

It should be understood that various changes and modifications to the preferred embodiments described above might also be apparent to those skilled in the art. Modifications can be made without departing from the spirit and scope of the invention and without diminishing its attendant advantages. It is therefore intended that such changes and modifications be covered by the following claims.

What is claimed is:

1. A method of establishing a customized electronic site for the purposes of providing products, the method comprising:
a. obtaining over a network information specifying criteria for the customized electronic site, wherein the criteria include a selection of products and descriptions; and
b. using the information to automatically establish a customized electronic site.

2. A method according to claim 1, wherein the information is obtained by a primary electronic site.

3. A method according to any of claims 1-2, wherein automatically establishing a customized electronic site includes automatically establishing a database containing the specified criteria.

4. A method according to any claims 1-3, wherein automatically establishing a customized electronic site includes automatically establishing a database containing the selection of products and descriptions.

5. A method according to any of claims 1-4, wherein automatically establishing a customized electronic site includes automatically establishing a database containing format preferences for the customized electronic site.

6. A method according to any of claims 2-5, wherein the primary electronic site includes a first selection/purchase engine.

7. A method according to claim 6, wherein establishing a customized electronic site includes replicating the first selection/purchase engine for use by the customized electronic site.

8. A method according to claim 6, wherein establishing a customized electronic site includes enabling the customized electronic site to use the first selection/purchase engine.

9. A method according to claim 6, wherein establishing a customized electronic site includes providing a second selection/purchase engine for use by the customized electronic site.

10. A method according to any of claims 1-9, further comprising:
a. obtaining a set of user ratings of the selection of products and descriptions over the network;
b. analyzing the set of user ratings through a primary electronic site; and
c. automatically suggesting products that confirm to a user's preferences.

11. A method according to any of claims 1-10, further comprising:
a. obtaining a set of consumer ratings of the selection of products and descriptions over the network;
b. analyzing the set of consumer ratings through the customized electronic site; and
c. automatically suggesting products that confirm to a consumer's preferences.

12. A method according to any of claims 10-11, wherein the analysis is performed with a preference analysis methodology.

13. A method according to claim 12, wherein the preference analysis methodology includes a collaborative filtering process.

14. A method according to any of claims 1-13, wherein the network is the Internet.

15. A method according to any of claims 2-14, wherein the customized electronic site is part of a primary electronic site.

16. A method according to any of claims 2-14, wherein the customized electronic site is separate from a primary electronic site.

17. A method according to any of claims 1-14, wherein the criteria include a selection of goods descriptions.

18. A method according to any of claims 1-14, wherein the criteria include a selection of pre-specified goods descriptions.

19. A method according to any of claims 1-14, wherein the criteria include a selection of services descriptions.

20. A method according to any of claims 1-14, wherein the criteria include a selection of pre-specified services descriptions.

21. A method according to any of claims 1-14, wherein obtaining information includes providing over a network a template that elicits user-specified data.

22. A method according to claim 21, wherein the template includes a web page.

23. A method according to any of claims 1-14, wherein the customized electronic site pertains to customized goods and the criteria includes customization data pertinent to customizing the goods.

24. A method according to claim 23, wherein the customization data includes a logo.

25. A method according to claim 24, wherein the logo is transmitted via electronic upload.

26. A method according to claim 24,wherein the logo is transmitted via facsimile.

27. A method according to claim 24, wherein the logo is transmitted via e-mail.

28. A method according to claim 24, wherein the logo is transmitted via electronic download.

29. A method according to claim 24, wherein the logo is transmitted via regular mail.

30. A method according to any of claims 1-14, wherein the criteria include a selection of pre-specified marketing materials that are transmitted across the network.

31. A method according to claim 30, wherein the marketing materials includes advertisements.

32. A method according to any of claims 1-14, wherein the criteria include a selection of links that are transmitted across the network.

33. A method according to claim 32, wherein the selection of links includes data ports.

34. A method according to any of claims 32-33, wherein the selection of links includes information pertinent to the products.

35. A method according to any of claims 1-14, wherein the criteria include a selection of linkages between a primary electronic site and the customized electronic site.

36. A method according to any of claims 1-14, wherein the criteria include a selection of linkages between the customized electronic site and resources pertinent to the customized electronic site.

37. A method according to any of claims 17-18 and 23, wherein the primary electronic site provides the selection of goods and effects delivery of the goods to a user in bulk.

38. A method according to any of claims 17-18 and 23, wherein the primary electronic site provides the selection of goods and effects delivery of the goods individually to a user.

39. A method according to any of claims 19-20, wherein the primary electronic site provides the selection of services and effects performance of the services for a user.

40. A method according to any of claims 17-18, 23, and 37-38, wherein the selection of goods are inventoried by the primary electronic site.

41. A method according to any of claims 19-20 and 39, wherein the selection services are inventoried by the primary electronic site.

42. A method according to any of claims 17-18, 23 and 37-38, wherein the primary electronic site provides the selection of goods and effects delivery of the goods to a consumer.

43. A method according to any of claims 19-20 and 39, wherein the primary electronic site provides the selection and effects performance of the services for a consumer.

44. An apparatus for providing a customized electronic site, the apparatus comprising:
a. a primary electronic site, the primary electronic site including a root directory for collecting information pertinent to the customized electronic site;
b. at least one dedicated server for serving the primary electronic site and the customized electronic site; and
c. a primary database in communication with the at least one dedicated server, the database including images and descriptions of products offered by the primary electronic site and by the customized electronic site.

45. An apparatus according to claim 44, wherein the primary electronic site includes a web page.

46. An apparatus according to any of claims 44-45, further comprising at least one secondary database in communication with the at least one dedicated server, the secondary database including images and descriptions of goods offered by the primary electronic site and by the customized electronic site.

47. An apparatus according to any of claims 44-45, wherein the primary database includes descriptions of services offered by the customized electronic site.

48. An apparatus according to any of claims 44-46, wherein the at least one secondary database includes descriptions of services offered by the customized electronic site.

49. An apparatus according to any of claims 44-48, wherein the input and output of electronic data is via a wireless connection.

50. An apparatus according to any of claims 44-48, wherein the input and output of electronic data is via a hardwire connection.

51. An apparatus according to claim 50, wherein the hardwire connection includes a telephone.

52. An apparatus according to claim 50, wherein the hardwire connection includes a modem.

53. An apparatus according any of claims 44-52, wherein the primary web site includes a first selection/purchase engine.

54. An apparatus according to claim 53, wherein the customized electronic site includes a replicate of the first selection/purchase engine.

55. An apparatus according to claim 53, wherein the customized electronic site is in communication with the first selection/purchase engine.

56. An apparatus according to claim 53, wherein the customized electronic site includes a second selection/purchase engine.

57. A computer program product for implementing the methods of claims 2-14.
